(19) United States
(12) Patent Application Publication
(10) Pub. No.: US 2014/0150759 A1
(43) Pub. Date: Jun. 5, 2014

(54) Engine Including External EGR System

(71) Applicant: GM GLOBAL TECHNOLOGY OPERATIONS LLC, Detroit, MI (US)

(72) Inventors: B. Jerry SONG, Novi, MI (US); Eric F. GRIMMINGER, Rochester Hills, MI (US); Cedric D. ARMAND, Royal Oak, MI (US)

(73) Assignee: GM GLOBAL TECHNOLOGY OPERATIONS LLC, Detroit, MI (US)

(21) Appl. No.: 13/693,140

(22) Filed: Dec. 4, 2012

(51) Int. Cl. F02M 25/07

(52) U.S. Cl. CPC F02M 25/077
USPC 123/568.19; 123/568.11

(57) ABSTRACT

An engine assembly includes an engine structure defining a combustion chamber. An intake system includes an intake manifold in communication with the combustion chamber. An exhaust system includes an exhaust conduit in communication with the combustion chamber. An exhaust gas recirculation system includes an EGR tube providing communication between the intake and exhaust systems, the EGR tube includes an end portion extending a distance into the intake system in a direction opposing air flow to the intake manifold.

### FIELD

The present disclosure relates to engine exhaust gas recirculation systems.

### BACKGROUND

This section provides background information related to the present disclosure which is not necessarily prior art.

Internal combustion engines may include exhaust gas recirculation systems to provide exhaust gas to the combustion chambers for a subsequent combustion event. External exhaust gas recirculation systems may reintroduce the exhaust gas to the combustion chambers by providing the exhaust gas to the intake system downstream of the throttle valve.

### SUMMARY

The present disclosure provides an engine assembly including an engine structure defining a combustion chamber. An intake system includes an intake manifold in communication with the combustion chamber. An exhaust system includes an exhaust conduit in communication with the combustion chamber. An exhaust gas recirculation system includes an EGR tube providing communication between the intake and exhaust systems, the EGR tube includes an end portion extending a distance into the intake system in a direction opposing air flow to the intake manifold.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only and are not intended to limit the scope of the present disclosure in any way.

FIG. 1 is a schematic illustration of an engine assembly according to the present disclosure; and

FIG. 2 is a fragmentary section view of the engine assembly shown in FIG. 1.

Corresponding reference numerals indicate corresponding parts throughout the several views of the drawings.

### DETAILED DESCRIPTION

Examples of the present disclosure will now be described more fully with reference to the accompanying drawings. The following description is merely exemplary in nature and is not intended to limit the present disclosure, application, or uses.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

When an element or layer is referred to as being “on,” “engaged to,” “connected to” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

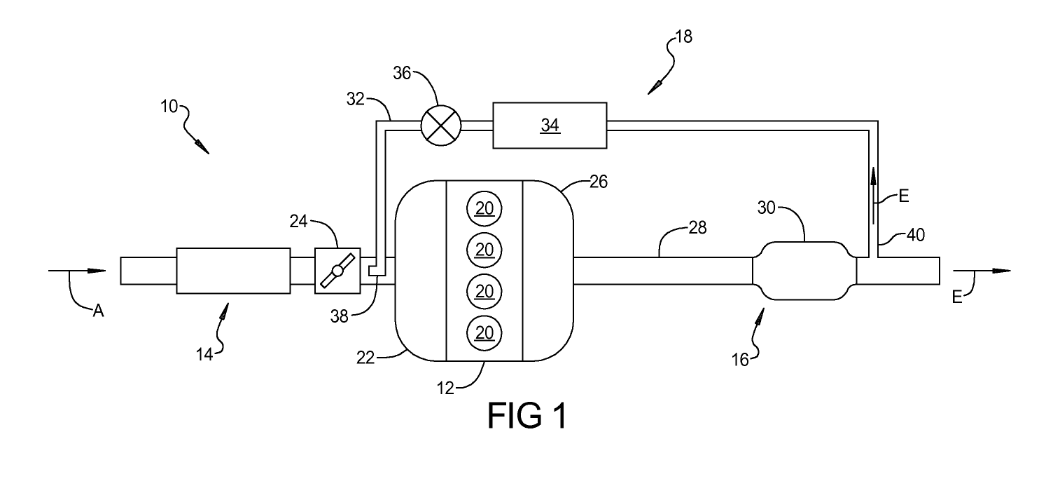

With reference to FIG. 1, an engine assembly 10 may include an engine structure 12, an intake system 14, an exhaust system 16, and an exhaust gas recirculation (EGR) assembly 18. The engine structure 12 may define cylinder bores 20 forming combustion chambers. The engine structure 12 may include an engine block defining the cylinder bores 20 and a cylinder head coupled to the engine block and defining intake and exhaust ports in communication with the combustion chambers.

An inline engine configuration having four cylinders is schematically shown in FIG. 1 for illustration purposes only. It is understood that the present teachings apply to any number of piston-cylinder arrangements and a variety of reciprocating engine configurations including, but not limited to, V-engines, inline engines, and horizontally opposed engines, as well as both overhead cam and cam-in-block configurations.

The intake system 14 may include an intake manifold 22 coupled to the engine structure 12 and in communication with the combustion chambers and a throttle valve 24 in communication with the intake manifold 22 that controls air flow (A) to the intake manifold 22. The exhaust system 16 may include an exhaust manifold 26 coupled to the engine structure 12 and in communication with the combustion chambers, an exhaust conduit 28 extending from the exhaust manifold 26 and in communication with the combustion chambers and a catalyst 30 located in the exhaust conduit 28.

The EGR assembly 18 may include an EGR tube 32 extending from the exhaust system 16 to the intake system 14 and providing communication between the intake and exhaust systems 14, 16, an EGR cooler 34 located along the EGR tube 32 and an EGR control valve 36 in the EGR tube 32. The EGR tube 32 may include an end portion 38 extending from the intake system 14 at a location between the throttle valve 24 and the intake manifold 22 and an end portion 40 extending from the exhaust conduit 28 at a location downstream of the catalyst 30. In some arrangements, the EGR control valve 36 may be located between the EGR cooler 34 and the intake system 14. Alternatively, the EGR control valve 36 may be located between the EGR cooler 34 and the exhaust end portion 40.

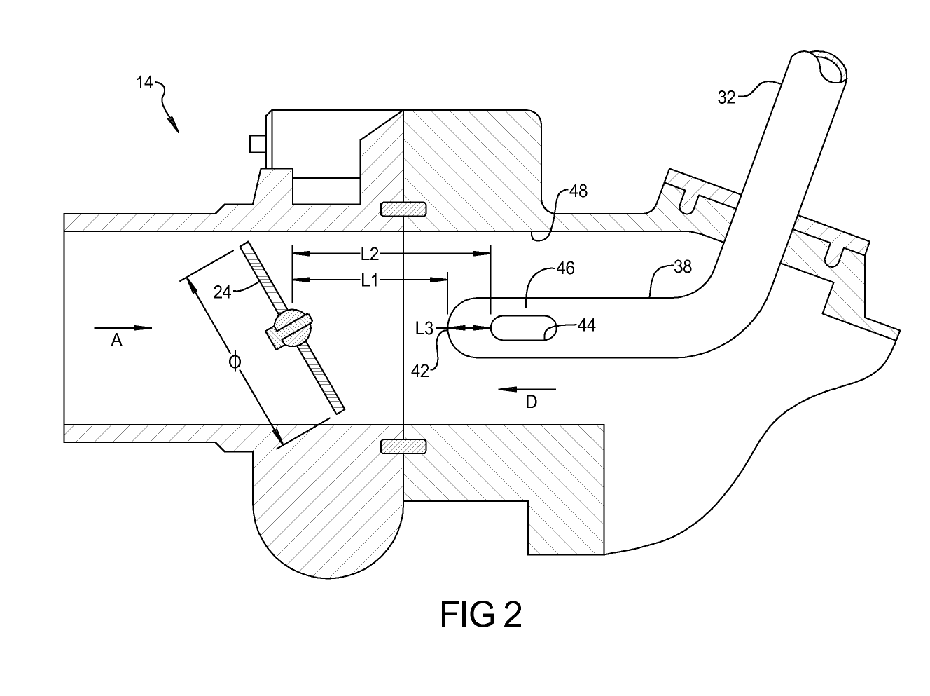

With reference to FIG. 2, the end portion 38 may extend a distance into the intake system 14 in a direction (D) opposing air flow (A) to the intake manifold 22. Alternatively, the end portion 38 may extend in the direction of air flow (A). The end portion 38 may extend generally parallel to a flow direction of air flow (A) within the intake system 14 at the location of the end portion 38. More specifically, the end portion 38 may extend in the direction (D) toward the throttle valve 24. The longitudinal end 42 of the end portion 38 facing the throttle valve 24 may be closed and may define a rounded profile.

At least one opening 44 may extend through a side wall 46 of the end portion 38 of the EGR tube 32 within the intake system 14. In the present non-limiting example, two openings 44 extend through the side wall 46 (one shown) on opposite sides from one another. The intake system 14 may define a concentric flow path 48 around the perimeter of the end portion 38 and the openings 44 may face a direction generally perpendicular to the flow direction of air flow (A) within the intake system 14 at the location of the openings 44.

The longitudinal end 42 of the EGR tube 32 may be spaced a distance (L1) from a pivot region of the throttle valve 24. The openings 44 may each be spaced a distance (L2) from the pivot region of the throttle valve 24. The openings 44 may be longitudinally spaced along the end portion 38 a distance (L3) from the longitudinal end 42 of the EGR tube 32.

The openings 44 may have an effective diameter at least equal to the effective diameter of the end portion 38 of the EGR tube 32 to produce no significant pressure loss as a result of exhaust gas flow through the openings 44. The effective flow area of the concentric flow path 48 may define an effective diameter to allow air flow through the intake system 14 during wide open throttle conditions.

The arrangement of end portion 38 of the EGR tube 32 within the intake system 14 and the orientation of the openings 44 may enhance mixing of the recirculated exhaust gas (E) with intake air (A) within the intake system 14. More specifically, the throttle valve 24 and the rounded profile of the longitudinal end 42 of the EGR tube 32 proximate the throttle valve 24 may induce a turbulent flow field in the intake system 14 at the openings 44. The turbulent flow field and orientation of the openings 44 may provide the enhanced mixing of the recirculated exhaust gas (E) with the intake air (A) within the intake system 14.

Additionally, the orientation of the openings 44 in the end portion 38 of the EGR tube 32 relative to the concentric flow path 48 defined by the intake system 14 may create a reduced pressure region at the openings 44 within the intake system 14. This reduced pressure region may draw exhaust gas through the EGR tube 32 to the intake system (similar to a venturi).

What is claimed is:

1. An engine assembly comprising:
an engine structure defining a combustion chamber;
an intake system including an intake manifold in communication with the combustion chamber;
an exhaust system including an exhaust conduit in communication with the combustion chamber; and
an exhaust gas recirculation system including an EGR tube providing communication between the intake and exhaust systems, the EGR tube including an end portion extending a distance into the intake system in a direction opposing air flow to the intake manifold.

2. The engine assembly of claim 1, wherein the end portion of the EGR tube extends generally parallel to a flow direction of intake air within the intake system.

3. The engine assembly of claim 1, wherein the intake system includes a throttle valve adapted to control air flow to the intake manifold and the end portion of the EGR tube extends into the intake system at a location between the intake manifold and the throttle valve, the end portion of the EGR tube extending within the intake system in a direction toward the throttle valve.

4. The engine assembly of claim 3, wherein a longitudinal end of the end portion of the EGR tube facing the throttle valve is closed and the end portion of the EGR tube includes at least one opening extending through a side wall of the EGR tube within the intake system.

5. The engine assembly of claim 4, wherein the longitudinal end of the EGR tube is spaced a distance from a pivot region of the throttle valve.

6. The engine assembly of claim 5, wherein the at least one opening is spaced a distance from the pivot region of the throttle valve.

7. The engine assembly of claim 1, wherein the end portion of the EGR tube defines at least one opening extending through a side wall of the EGR tube.

8. The engine assembly of claim 7, wherein the at least one opening has an effective diameter at least equal to the effective diameter of the end portion the EGR tube to produce no significant pressure loss as a result of exhaust gas flow through the at least one opening.

9. The engine assembly of claim 1, wherein the intake system defines a concentric flow path surrounding the end portion of the EGR tube.

10. The engine assembly of claim 1, wherein the end portion of the EGR tube includes a closed end defining a rounded profile.

11. The engine assembly of claim 10, wherein the intake system includes a throttle valve adapted to control air flow to the intake manifold and the end portion of the EGR tube extends into the intake system at a location between the intake manifold and the throttle valve, the end portion of the EGR tube extending within the intake system in a direction toward the throttle valve with the closed end of the EGR tube facing the throttle valve.

12. The engine assembly of claim 11, wherein the end portion of the EGR tube includes at least one opening extending through a side wall of the EGR tube within the intake system, the throttle valve and the closed end of the EGR tube being adapted to induce a turbulent flow field in the intake system at the at least one opening.

13. The engine assembly of claim 1, wherein a concentric flow path is defined by the intake system around a perimeter of the end portion of the EGR tube.

14. The engine assembly of claim 13, wherein the end portion of the EGR tube extends parallel to a flow direction of intake air within the intake system and includes a closed end and at least one opening extending through a side wall of the EGR tube and facing a direction perpendicular to the flow direction of intake air within the intake system.

15. An engine assembly comprising:
an engine structure defining a combustion chamber;
an intake system including an intake manifold in communication with the combustion chamber and a throttle valve adapted to control air flow to the intake manifold;
an exhaust system including an exhaust conduit in communication with the combustion chamber; and
an exhaust gas recirculation system including an EGR tube in communication with the intake and exhaust systems, the EGR tube including an end portion extending a distance into the intake system at a location between the throttle valve and the intake manifold, the end portion extending in a direction opposing air flow to the intake manifold and parallel to the air flow, the end portion defining a closed longitudinal end having a rounded profile proximate to the throttle valve with at least one opening extending through a side wall of the end portion of the EGR tube.

16. The engine assembly of claim 15, wherein the longitudinal end of the EGR tube is spaced a distance from a pivot region of the throttle valve.

17. The engine assembly of claim 16, wherein the at least one opening is spaced a distance from the pivot region of the throttle valve.

18. The engine assembly of claim 15, wherein the at least one opening has an effective diameter at least equal to the effective diameter of the end portion the EGR tube to produce no significant pressure loss as a result of exhaust gas flow through the at least one opening.

19. The engine assembly of claim 15, wherein the intake system defines a concentric flow path surrounding the end portion of the EGR tube.

20. An engine assembly comprising:
an engine structure defining a combustion chamber;
an intake system including an intake manifold in communication with the combustion chamber and a throttle valve adapted to control air flow to the intake manifold;
an exhaust system including an exhaust conduit in communication with the combustion chamber; and
an exhaust gas recirculation system including an EGR tube in communication with the intake and exhaust systems, the EGR tube including an end portion extending a distance into the intake system at a location between the throttle valve and the intake manifold, the end portion extending in a direction opposing air flow to the intake manifold and parallel to the air flow, the end portion defining a closed longitudinal end having a rounded profile proximate to the throttle valve with at least one opening extending through a side wall of the end portion of the EGR tube, the longitudinal end of the EGR tube being spaced a distance from a pivot region of the throttle valve and the at least one opening being spaced a distance from the pivot region of the throttle valve, the at least one opening having an effective diameter at least equal to the effective diameter of the end portion the EGR tube to produce no significant pressure loss as a result of exhaust gas flow through the at least one opening and the intake system defining a concentric flow path surrounding the end portion of the EGR tube.
